(19) United States
(12) Patent Application Publication
(10) Pub. No.: US 2017/0068980 A1
(43) Pub. Date: Mar. 9, 2017

(54) Online Multi-Level Buy-Sell Rewards System

(71) Applicants: Daniil Tseytlonok, Alameda, CA (US); Evgen Prudchyenko, Alameda, CA (US)

(72) Inventors: Daniil Tseytlonok, Alameda, CA (US); Evgen Prudchyenko, Alameda, CA (US)

(21) Appl. No.: 15/353,131

(22) Filed: Nov. 16, 2016

Related U.S. Application Data
(63) Continuation-in-part of application No. 14/826,609, filed on Aug. 14, 2015.
(60) Provisional application No. 62/039,529, filed on Aug. 20, 2014.

(51) Int. Cl. G06Q 30/02

(52) U.S. Cl. CPC G06Q 30/0214; G06Q 30/0239

(57) ABSTRACT

An online multi-level buy-sell rewards system includes a network server. A consumer database includes consumer records associated with buyers. A seller database includes product records associated with sellers. The processor receives purchase data from a buyer indicative of a selection of a product offering made by a seller. A chain of referral data associated with the buyer and seller is determined from the consumer database, including a referrer of the buyer/seller, the referrer of the referrer of the buyer/seller, and so on. A portion of the purchase price is set aside for distribution to levels of buyer and seller referrers. A predetermined amount of the reward portion is distributed to charity and to a buyer's retirement account.

### REFERENCE TO RELATED APPLICATIONS

This application claims the benefit of application Ser. No. 14/826,609 filed Aug. 14, 2015 titled Online Multi-Level Buy-Sell Rewards System, which claims the benefit of provisional patent application U.S. Ser. No. 62/039,529 filed Aug. 20, 2014 titled Online Multi-Level Buy-Sell Rewards System which is incorporated herein by reference.

### BACKGROUND OF THE INVENTION

This invention relates to online systems for advertising, buying, and selling of goods and services and, more particularly, to an online multi-level buy-sell rewards system that provides incentives for recruiting new members to the system. In particular, new buyers and new sellers are recruited in that multiple levels of referrers join in receiving rewards on every sale. A charitable organization also receives a portion of the rewards. Further, a portion of a buyer's rewards may be directed to his retirement account.

Traditional methods of advertising and selling provide the incentive of a discount by means of a coupon, the benefit being to a consumer who saves money on the purchase and to a seller in the sale of a product associated with the coupon. The disadvantage of the traditional system is the cost to the seller of printing, advertizing, and distributing the coupons and that the coupon must be present and redeemed at a point of sale for a particular product, such as in a store or by entering a coupon identifier (coupon or QR code) in an online sale transaction. Further, the disadvantages of the present systems include the high upfront cost of advertising and the relative complexity of a seller choosing the most effective ad campaigns or media. In addition, a buyer is only motivated to act for himself relative to a single product and is not motivated by the purchases of others.

Therefore, it would be desirable to have an online multi-level buy-sell rewards system that incentivizes a consumer not only receiving back a portion of a purchase price but also an amount of later purchases by those he refers to the system, by those the referred buyer refers to the system, and so on. Further, it would be desirable to have an online multi-level buy-sell rewards system that also incentivizes members to refer other sellers of products to the system in a similar multi-level manner. In addition, it would be desirable to have an online multi-level buy-sell rewards system that distributes a portion of every sale to charity and, selectively, to a registered consumer's retirement account. And as a specific benefit to consumer users of the system, it would be desirable to have an online rewards system that enables a user to deposit a portion of every reward to his retirement account.

### SUMMARY OF THE INVENTION

An online multi-level buy-sell rewards system according to the present invention includes a computer server having a processor connected to a network and having a memory for storing data structures and programming. A seller database stored in memory includes a plurality of product records associated with a plurality of sellers. A consumer database stored in memory includes a plurality of consumer records. Programming stored in memory causes the processor to receive purchase data from a registered buyer that is indicative of a selection of a product offering made by a registered seller. A chain of referral data associated with the registered buyer is determined from the consumer database, including a referrer of the registered buyer, the referrer of the referrer of the registered buyer, and so on. A portion of the purchase price is calculated to be distributed as rewards, a predetermined amount being distributed to various levels of buyer referrers.

Similarly, a chain of referral data associated with the seller is determined from the seller database, including a referrer of the seller, a referrer of the referrer of the seller, and so on. A predetermined amount of the reward portion is distributed to various levels of seller referrers. In addition, a predetermined amount of the reward portion is distributed to a charitable organization. In some embodiment, a predetermined portion of every registered consumer reward is directed into the consumer's retirement account (e.g. an IRA); in time, the additional contributions and interest will be very significant.

Therefore, a general object of this invention is to provide an online multi-level buy-sell rewards system that utilizes a multi-level marketing paradigm for recruiting both buyers and sellers to participate in the buy-sell system.

Another object of this invention is to provide an online rewards system, as aforesaid, that provides future monetary rewards to members who refer new buyers or sellers to the system by distributing a portion of every sale to a referral line.

Still another object of this invention is to provide an online rewards system, as aforesaid, that calculates a rewards portion of a product sale and distributes it to the buyer, a member who referred the buyer, to the referrer of the referrer, and so on.

Yet another object of this invention is to provide an online rewards system, as aforesaid, that distributes predetermined amounts of the rewards portion to the seller of the purchased product, to a member who referred the seller to the system, to the referrer of the referrer of the seller, and so on.

A further object of this invention is to provide an online rewards system, as aforesaid, that distributes a predetermined amount of the rewards portion of every sale to a charitable organization.

Another object of this invention is to provide an online rewards system, as aforesaid, that automatically distributes a portion of a respective consumer's reward portion to the consumer's retirement account.

A still further object of this invention is to provide an incentivized method for advertising goods and services that leads to recruiting new members to the system.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a block diagram of an online multi-level buy-sell rewards system according to a preferred embodiment of the present system illustrating how the system is accessible over the internet and operated as a network server system.

FIG. 2 is a block diagram of the online rewards system as in FIG. 1 illustrating the network server system;

FIG. 3 is illustrating the contents of a computer memory according to the present invention;

FIG. 4 is a flowchart illustrating the logic performed by a processor to operate a purchase and distribution event according to the present invention; and

FIG. 5 is a flowchart illustrating the logic performed by a processor to perform a setup and initiation process of the system.

### DESCRIPTION OF THE PREFERRED EMBODIMENT

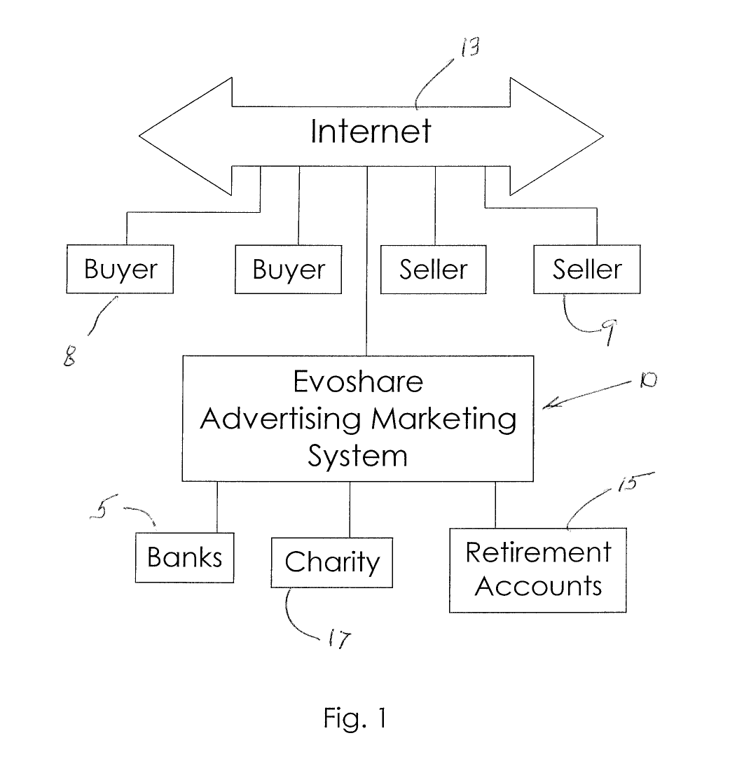

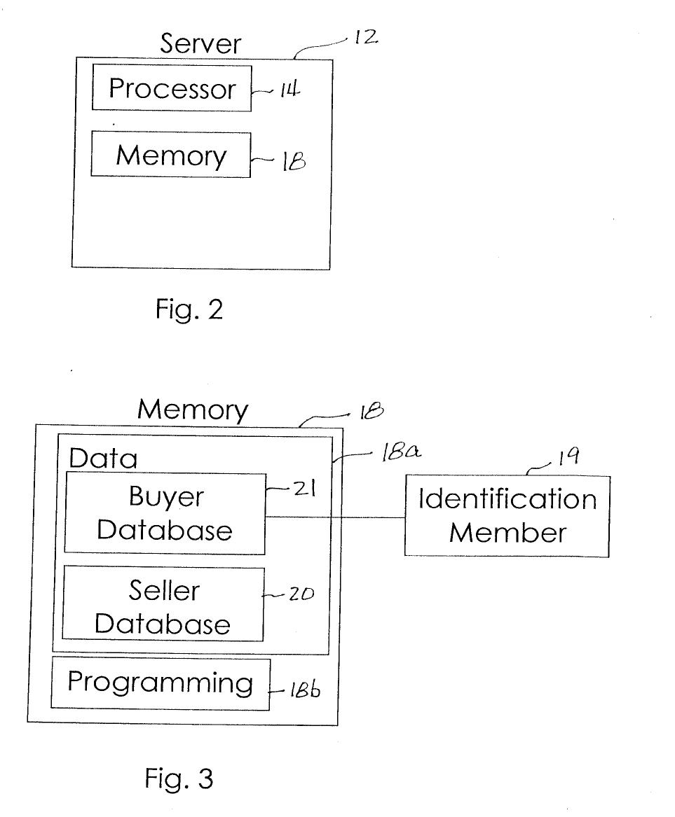

An online multi-level buy-sell rewards system will now be described in detail with reference to FIGS. 1 to 5 of the accompanying drawings. More particularly, the online multi-level buy-sell rewards system 10 includes at least one computer 12 such as a network server, operably connected to a wide area network such as the internet 13 and accessible by remote computers in a traditional manner (FIG. 1). Specifically, the rewards system 10 is designed to be used by buyers to view and purchase products offered by sellers 9. The system 10 may be configured and managed by an administrator having security access to all aspects of the computer, memory, including data and programming. The present invention, however, includes more than merely a computer executing programming steps as will be disclosed below.

The computer 12 may include a non-volatile memory 1 configured to store a plurality of programming instructions 1a and a processor 14 configured to selectively execute the program instructions in a manner that operates the system 10 as will be described below. The memory 1 may also be structured so as to store a plurality of data structures 1b such as one or more databases and data that may be stored and manipulated by operation of the programming instructions.

Data structures 1b stored in the memory 1 may include, but are not limited to the databases described below. The system 10 may include a seller database 20 that may include a plurality of seller records associated with a seller that is a member of the system. (FIG. 3). Each seller record may include one or more product offerings. Each seller record may include, but not be limited to, login data, contact data, reward data, referrer data indicative of who referred the seller to the system. Similarly, the system 10 may include a buyer database 21 having a plurality of buyer records. Each buyer record may include, but not be limited to, login data, contact data, reward data, referrer data indicative of who referred the buyer to the system.

The processor 14, executing appropriate programming instructions, is capable of determining a chain of associated buyers, such as identifying who referred a buyer to the system, who referred the referrer of the buyer, and so on. Similarly, the processor 14, executing appropriate programming instructions, is capable of determining a chain of associated sellers, such as identifying who referred a seller to the system, who referred the referrer of the seller, and so on.

The databases may be filled with respective data by seller 9 and buyers who use the system 10. Preferably, buyers may be required to sign up as members before authorization is given to utilize the system 10 since buyers need to indicate where purchased items and later rewards are to be delivered, who referred him to the system, and other information. Similarly, sellers may be required to sign up as members before authorization is given to utilize the system 10 since sellers need to upload product offer data for use in the system 10, indicate who referred him to the system, and the like. Once a member, a seller may log in—such as with a username and password—and choose to upload product offer data to the seller database. Similarly a buyer may sign up, purchase products, and recommend others to the system.

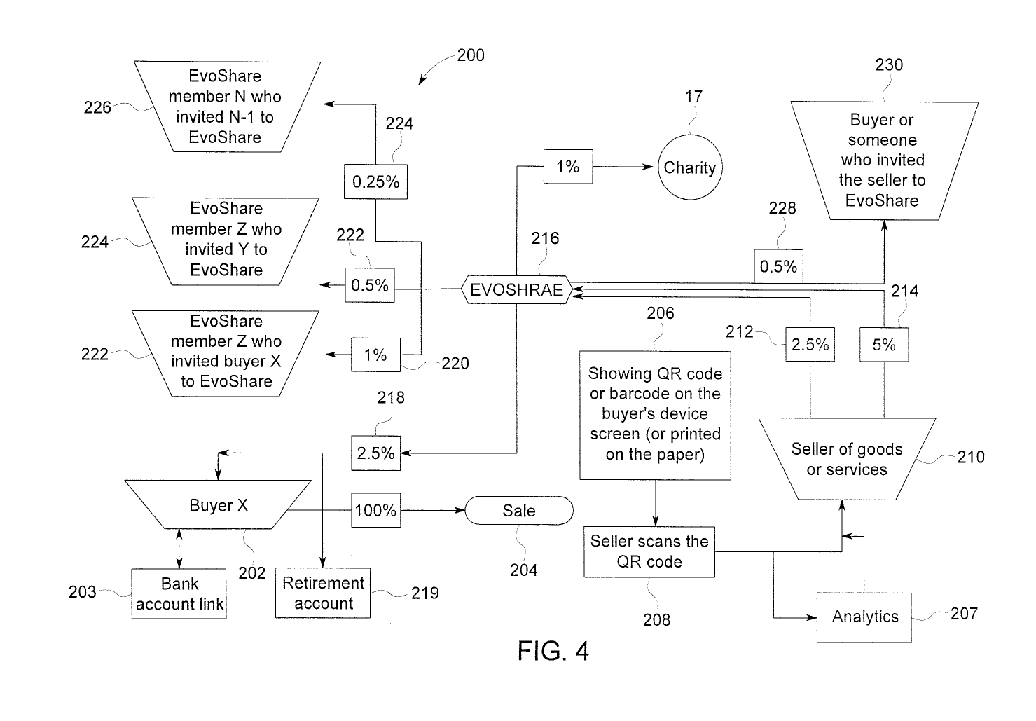

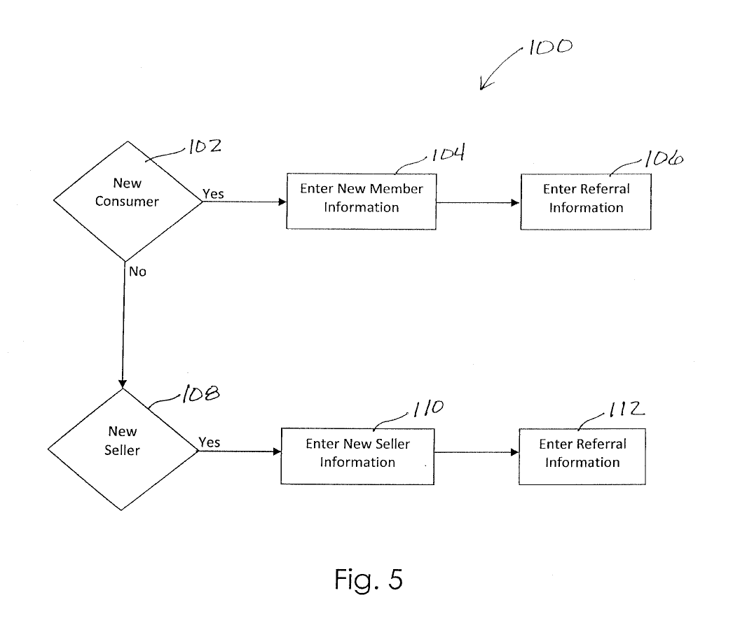

Operation of the system 10 according to an exemplary process is illustrated in the flowcharts of FIGS. 4 and 5 and will be described below. It is understood that the steps of the process are carried out by the processor 14 executing programming stored in memory 1. A setup process 100 is illustrated in FIG. 5 and includes programming for receiving seller and buyer data into respective databases as described above. At step 102, the processor 14 determines if the user is a new buyer and an unregistered member; if so, the process 100 proceeds to step 104. Otherwise, the process 100 proceeds to step 10. At step 104, the new buyer supplies new buyer membership data such as login information, physical contact information, retirement account data (IRA or 401K), any investment account, such as a 529 college savings account, 457, 403b, a mortgage or even to a student loan (to which a portion of a user's reward may be credited), bank account data (to confirm that a user made a purchase from a member seller), referral data (i.e. who referred the buyer to the system), and the like. All of the various accounts discussed above (such as a retirement account, IRA, 401K, 529, 457, 403b, mortgage, etc.) will be referred to in the claims and specification as a “specialty account” rather than being specifically listed. A buyer account is created and stored as a data structure in memory 1. It is understood that the system 10 may be in data communication, such as via the internet, with remote banks 5, with remote retirement account resources 15, (including investment accounts, mortgage or student loans, and the like).

At step 10, the processor determines if the user is a new seller and unregistered; if so, the process 100 proceeds to step 110. At step 110, the new seller supplies new seller data such as login information, physical contact information, product offer records, referral data (i.e. who referred the seller to the system), and the like. A seller account is created and stored as a data structure in memory 1.

The process 200 is illustrated in FIG. 4 and explains operation of the buy-sell rewards methodology according to the present invention. A buyer who is a member of the marketing system 10 may view product offers that have been uploaded by a plurality of member sellers. Reference numeral 203 reflects that a buyer's records may be linked to a respective bank account or other financial institution as indicated previously and for use in analytics in step 207 described below. The act of a buyer using the system is illustrated at step 202 (FIG. 4). When a desired product purchase has been selected or determined, the buyer may make an online (or offline) purchase, as indicated at step 204. The purchase transaction may include displaying a barcode or QR code on the buyer's computer screen (or any mobile computing device) as indicated at step 206.

In one embodiment, the consumer may present his QR code in the form of a printed label, or even a screen print on a hat or shirt. In other words, the buyer may be given an actual physical identification member 19 separate and independent of the associated data in the computer server 12 by which his associated buyer data may be identified. For example, a member buyer new to the system may be given a hat, shirt, or other token having a barcode or QR code label that identifies the buyer and his associated information when scanned by a product identification scanner associated with a seller or store (tangible or virtual) that has implemented the system according to the present invention. In that case the QR code contains the buyer member ID only. In one embodiment, the barcode or QR code may be scanned by the seller after the transaction is selected by the consumer. In one embodiment, the purchase may be made by scanning the barcode or QR code as indicated at step 20. In other words, the processor 14, under program control, receives purchase data from the buyer indicative of selection of a product offering made by the buyer as well as buyer identification information.

The process 200 proceeds to step 207 where predetermined analytics may be performed with respect to the purchase having just been made. For instance, the system may be programmed to confirm that the product is associated with a member seller and that the product was purchased using a bank account associated with the member buyer. The system 10 may be operatively connected via the internet 13. As indicated previously, a buyer member may record his bank account data during the setup process 100. This enables reports to be generated to track a respective user's reward earnings, statistics regarding a user's use of member sellers, and other useful statistics. Process 200 then proceeds to step 210.

By receiving the purchase selection, the processor 14 is able at step 210 to determine the identity of the buyer, the identity of the seller, and the total amount of the purchase and will use this information to determine reward distributions as will be described below. The process 200 proceeds simultaneously to steps 212 and 214. At steps 212 and 214, the processor 14 determines a predetermined amount of the amount of the sale transaction to be credited to the instant buyer, such as 2.5% as shown in step 212. In addition, the processor 14 determines a predetermined amount of the sale transaction to be distributed to a chain of buyers, such as 5% as shown in step 214.

The process 200 proceeds to step 216 where the processor 14 executes programming that calculates and distributes a predetermined amount of the purchase price to the buyer as shown at step 21 where 2.5% is distributed to the buyer. The portion of the purchase price to be distributed may be referred to as the “rewards portion.” In an embodiment, a buyer that has set up his profile regarding a special account 15 may, at step 219, cause a portion of his reward distribution to be directed to the linked account (e.g. a retirement account, investment account, bank loan, etc. as described above). The retirement, investment, loan, or other specialty account may be administered by the system 10 or it may be administered by a bank or other institution. It is understood that this direction of a reward portion to the user's retirement account is accomplished automatically under program control.

In an embodiment, the processor 14 may round up every regular sales transaction to the next highest integer and contribute the “spare change” to the retirement account of an associated buyer. In a related embodiment, the processor specifically determines a mathematical difference between a consumer reward of a buyer and a next higher integer. Then, this “spare change” (i.e. the mathematical difference) may be contributed to the retirement account associated with the registered consumer who made the purchase transaction.

Similarly, the consumer reward (or a portion thereof) of a buyer may be distributed to a student loan account that was predetermined and entered by a buyer. In the manner described above, application of a registered buyer's rewards may be seamlessly and automatically applied to various financial transactions—thus providing future financial benefits.

Also at step 216, the processor 14 determines a chain of members who will share in receiving the predetermined reward portion. For instance, 1% of the reward portion may be distributed to a member who referred the buyer to the system 10, as indicated at steps 220 and 222, respectively. Similarly, a member that referred the referrer of the buyer may also receive a portion of the reward portion, such as 0.5% of the portion to be distributed, as illustrated at steps 224 and 226, respectively. Step 216 of the process 200 continues in this manner to distribute increasingly smaller portions of the rewards portion to referrers of a previous level referrer as illustrated in steps 224 and 226, respectively.

Similarly, the processor 14 determines a predetermined amount of the rewards portion to be distributed to the seller of the purchased product offer. In one embodiment, this amount may be distributed directly to the seller. In another embodiment, this predetermined amount may be distributed to a buyer or seller member who invited or referred the seller to the system as indicated at steps 22 and 230. Also at step 216, the processor 14 calculates a predetermined amount of the rewards portion and directs a distribution to a predetermined charitable organization 17.

Therefore, the online multi-level buy-sell rewards system 10 incentivizes both buyer and seller members of the system to recruit new members. In other words, the benefit of membership is not just for the member himself as with a traditional coupon based method. Rather, the present rewards system is a multi-level incentive system that rewards a buyer both for purchases and also every time someone that he refers to the system makes a purchase. In fact, a member receives a share of every purchase made in his “down line” of a chain of referrals. Finally, the present system has a public policy benefit of donating a portion of every sale to charity.

Now is presented a “real world” example of how the system and method described above is implemented and executed in a payroll environment to the employees advantage:
1. The employee buys something at an EvoShare-participating business
2. The store pays a commission to EvoShare.
3. EvoShare deposits cash-back into the individual's checking account and notifies on behalf of the employee either the employee's employer or payroll provider to make an additional deduction from his/her next paycheck. The deduction amount is always equal to the deposited amount into the checking account.
   Thus, there is no indirect contribution. The funds always come from the employee's paycheck. Moreover, the employees pay fewer taxes.

Here is an example, where Joe (the employee) makes $8,000 per month with no matching to 401k from the employer.

Without EvoShare

| | |
|---|---|
| Gross Income | $8,000 |
| Contribution to 401k | $160 |
| (2%) | |
| Adjusted Gross | $7,840 |
| Taxes (25% rate) | $1,960 |
| Take-home pay | $5,880 |
| Total Cash | $5,880 |
| Total savings | $160 |

With EvoShare. Joe makes purchases at participating
stores and he has earned $200 cash back.

| | |
|---|---|
| Gross Income | $8,000 |
| Contribution to 401k (2%) | $160 |
| Contribution because of | $200 |
| EvoShare to 401k | |
| Adjusted Gross | $7,640 |
| Taxes (25% rate) | $1,910 |
| Take-home pay | $5,730 |
| Cash back to checking account | $200 (non-taxable) |
| Total Cash | $5,930 |
| Total savings | $360 |

Conclusions: With EvoShare, Joe pays fewer taxes, makes more savings and gets more cash.

It is understood that while certain forms of this invention have been illustrated and described, it is not limited thereto except insofar as such limitations are included in the following claims and allowable functional equivalents thereof.

1. An online multi-level buy-sell rewards system for use with a wide area network, comprising:
a computer server having a processor connected to the wide area network and that provides a user interface to the network;
a non-volatile memory in said computer server in data communication with said processor and configured to store programming and data structures;
a seller database stored in said data structures in said memory that includes a plurality of product records associated with a plurality of registered sellers;
a consumer database stored in said memory that includes a plurality of consumer records;
programming in said memory that, when executed by said processor, causes said processor to:
receive purchase data from a registered consumer, said purchase data being indicative of an identity of said registered consumer and selection of a product offer by a respective registered seller;
determine from said consumer database a chain of buyer referral data associated with said registered consumer, said chain of buyer referral data including a referrer of said registered consumer, a referrer of said referrer of said registered consumer; and so on;
calculate from said purchase data a reward portion to be distributed as rewards;
distribute a predetermined amount of said reward portion to said registered consumer as a “consumer reward”;
distribute a predetermined amount of said consumer reward to a specialty account associated with and designated by said registered consumer.

2. The online multi-level buy-sell rewards system as in claim 1, wherein said programming, when executed by said processor, causes said processor to distribute a predetermined amount of said reward portion to respective referrers of said registered consumers.

3. The online multi-level buy-sell rewards system as in claim 2, wherein:
each consumer record selectively includes banking data associated with a respective registered consumer associated with a respective consumer record;
said programming, when executed, causes said processor to determine when said banking data is indicative that said respective consumer has made a purchase.

4. The online multi-level buy-sell rewards system as in claim 3, wherein said programming, when executed, causes said processor to determine, using said banking data and said consumer rewards associated with a respective registered consumer, a running total of said consumer rewards received by said respective registered consumer.

5. The online multi-level buy-sell rewards system as in claim 2, further comprising a physical buyer identification member independent from said server that includes an identification code associated with a respective consumer record by which respective consumer records associated with said identification code are selectively accessible.

6. The online multi-level buy-sell rewards system as in claim 2, comprising programming that, when executed, causes said processor to:
determine an identity of said respective registered seller associated with said selected product offer;
distribute a predetermined amount of said reward portion to said registered seller.

7. The online multi-level buy-sell rewards system as in claim 3, comprising programming that, when executed, causes said processor to:
determine from said seller database a chain of referral data associated with said registered seller, said chain of referral data including a referrer of said registered seller; and
distribute said reward portion to said referral chain associated with said registered consumer and to said referral chain associated with said registered seller according to a predetermined distribution schedule.

8. The online multi-level buy-sell rewards system as in claim 7, comprising programming that, when executed, causes said processor to distribute a predetermined amount of said reward portion to a predetermined charitable organization.

9. The online multi-level buy-sell rewards system as in claim 5, wherein said physical buyer identification member includes an article of clothing having one of a barcode, QR code, or encrypted image configured to identify a respective buyer record when scanned by a product code reading device.

10. The online multi-level buy-sell rewards system as in claim 1, comprising programming that, when executed, causes said processor to:
determine a mathematical difference between said reward portion and a next highest integer greater than said reward portion;
distribute said difference to said specialty account associated with said registered consumer.

11. A method for distributing rewards for buying and selling goods, comprising:
receiving purchase data on a computer server from a registered consumer that is indicative of an identity of said registered consumer and of a selection of a product offer made by a respective registered seller;
determining a chain of buyer referral data stored in a consumer database stored on said server that is associated with said registered consumer, said chain of buyer referral data including a referrer of said registered buyer, a referrer of said referrer of said registered buyer; and so on;
calculating from said purchase data a reward portion to be distributed as rewards;
distributing a predetermined amount of said reward portion to said registered consumer as a consumer reward and to respective referrers of said registered consumer; and
distributing a consumer-selected portion of said consumer reward to a specialty account associated with said registered consumer.

12. The method as in claim 11, wherein:
said computer server includes a consumer database stored in a memory that includes a plurality of consumer records; and
said computer server includes a seller database stored in said memory that includes a plurality of seller records.

13. The method as in claim 11, further comprising providing a physical buyer identification member independent from said server that includes an identification code associated with a respective consumer record by which respective consumer records associated with said identification code are selectively accessible.

14. The method as in claim 13, comprising:
determining an identity of said respective registered seller associated with said selected product offer; and
distributing a predetermined amount of said reward portion to said registered seller.

15. The method as in claim 14, comprising:
determining from said seller database a chain of referral data associated with said registered seller, said chain of referral data including a referrer of said registered seller; and
distributing said a predetermined portion of said reward portion to said referral chain associated with said registered seller according to a predetermined distribution schedule.

16. The method as in claim 14, comprising distributing a predetermined amount of said reward portion to a predetermined charitable organization.

17. The method as in claim 11, wherein an amount of said reward portion distributed to referrals decreases incrementally to prior levels of referrals.

18. The method as in claim 12, wherein:
each consumer record selectively includes banking data associated with a respective registered consumer associated with a respective consumer record;
said method comprising determining when said banking data is indicative that said respective consumer has made a purchase.

19. The method as in claim 18, comprising determining a running total of said consumer rewards received by said respective registered consumer using said banking data and said consumer rewards associated with a respective registered consumer.

20. The method as in claim 12, comprising:
determining a mathematical difference between said consumer reward and a next highest integer greater than said reward portion;
distributing said difference to said retirement account associated with said registered consumer.

21. The online multi-level buy-sell rewards system as in claim 1, wherein said specialty account is taken from a group consisting of a retirement account, an investment account, a mortgage loan, a student loan, and an educational savings account.
